(19) United States
(12) Patent Application Publication
(10) Pub. No.: US 2012/0313283 A1
(43) Pub. Date: Dec. 13, 2012

(54) Method for creating a hard cast replica of the human hand holding an object

(76) Inventor: Robert Neil England, Yeovil (GB)

(21) Appl. No.: 13/134,423

(22) Filed: Jun. 8, 2011

(51) Int. Cl. B29C 67/02

(52) U.S. Cl. 264/122

(57) ABSTRACT

An improved method for creating a hard cast replica of the human hand holding an object as shown in FIG. 1. Describing a suitably sized plastic container three quarters filled with an impression taking compound at 1. The subject hand holding a chosen object is then immersed into the compound at 2. With the moulding mix fully set the hand is removed leaving the object intact and inside the mould at 3. The void left by the removed hand is then filled with a suitable hard setting substance at 4. When the hard setting substance has fully cured the impression taking material can then be removed from the casting at 5. The result is a hard cast replica of the subject hand holding the original object at 6.

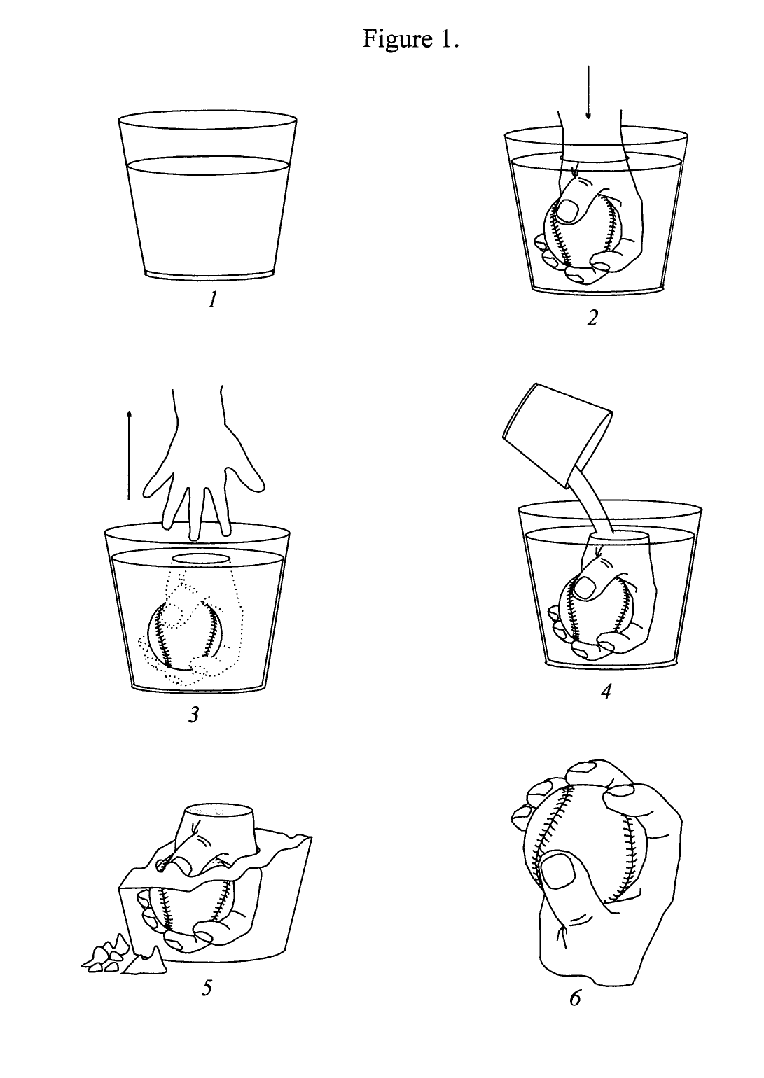

Combine, by weight, equal parts of sodium alginate powder and hydrated magnesium silicate powder. Volumes will depend on the size and intricacy of the composition of the subject hand and chosen object.

Add one part emulsifying oil to fifty parts ordinary tap water at an equal volume to the mixed powders and stir into the combination until a smooth and consistent compound is formed. With this method less water is required to achieve a constant mix which greatly improves the drying time for the set mould and reduces shrinkage and distortion of the taken impression.

The setting time for this method is approximately three to four minutes, depending on the temperature of the tap water and the inherent core temperature of the subject hand. The setting times can be extended or reduced depending on the amount of hydrated magnesium silicate is mixed with the sodium alginate. For example a ratio of two to one will extend the setting time by one to two minutes.

The compound material is poured into a suitable plastic container of a size that is relevant to the subject hand and the held object. It is essential that no part of the hand touches the sides or the base of the container during the impression taking process.

The subject hand holding the chosen object is slowly immersed into the mixture until the compound levels out around the wrist line. At this point the subject remains as still as possible until the impression has been formed. Extended setting times are recommended when creating impressions from the subject hands of the very young or the elderly or if the chosen object is of an intricate nature.

With the material set and the fine detailed impression taken, the subject hand is removed leaving the object intact and inside the mould. The inherent quality of the compound mixture used in this method is highly flexible and yet retains a tensile strength that resists tearing and distortion during the extraction of the hand.

This improved method creates a single piece mould which reduces the need for preparation of mould seams or the need to address flashings on the surface of the cast impression. The recorded detail Is finer and the shape and form of the replica is an accurate reproduction.

The void left by the extracted hand is invested with a hard setting substance that can be lightly agitated to release air bubbles which will improve the quality of the detail and the surface finish. The reduction of moisture content required for this method allows for improved drying times with little or no distortion, shrinkage or defects, which further allows for a greater variety of hard setting substances to be used.

The hard cast replica can now be removed from the moulding material, this is done by carefully peeling away the set compound in small pieces to gradually reveal the replica hand cast holding the original object.

The versatility of the improved method gives a wider range of choice with various and diverse hand held objects.

The finished article is a finely detailed replica casting of the human hand holding a chosen object that becomes a personalised and treasured ornament.

1. I claim an improved method for creating a hard cast replica of the human hand holding an object.
My improved method creates superior definition of fine detail taken from the given impression of the subject hand and the held object.
My improved method gives greater diversity in the range of setting times for the impression taking material.
My improved method gives greater diversity in the ability to take impressions of hands from a wider age range of subjects.
My improved method gives greater diversity in the range of objects capable of being held by the subject hand.
